(19) United States
(12) Patent Application Publication
(10) Pub. No.: US 2021/0122414 A1
(43) Pub. Date: Apr. 29, 2021

(54) ADJUSTABLE FRONT AXLE FOR A TOWABLE TRAILER

(71) Applicant: Dan Araujo, Anaheim, CA (US)

(72) Inventor: Dan Araujo, Anaheim, CA (US)

(21) Appl. No.: 16/662,444

(22) Filed: Oct. 24, 2019

(51) Int. Cl. B62D 13/06

(52) U.S. Cl. CPC B62D 13/06; B60G 2200/464

(57) ABSTRACT

An adjustable front axle for a towed trailer comprising: an axle that comprises an axle shaft and two pivot points, an axle lever; an actuator; two spindles; two spindle blocks; two wheels; and two kingpins. The actuator is configured to rotate the axle shaft and the two spindles from a positive canter angle to a negative canter angle, which causes the camber angle of the wheels to go from negative or neutral to positive. The towed trailer may have a pivotable draw bar.

### FIELD OF USE

The present disclosure relates to an adjustable front axle for a towable trailer. More specifically, the present disclosure relates to a towable trailer that is capable of selectively adjusting its front axle and tire positions in order to improve the driver's control over the trailer while reversing said trailer, which reduces the difficulty associated with driving in reverse when there is a trailer attached to the vehicle.

### BACKGROUND

Towing a trailer from the back of a vehicle can be a difficult task. This is because a driver only has direct control over the steering of the towing vehicle, not the towed trailer. This makes it difficult to navigate turns or other curves while driving. Trailer hitches, by design, have a certain amount of rotational flexibility in their connection between the towing vehicle and the towed trailer, an example of which would be the ball and socket trailer hitch connection. While a perfectly rigid trailer hitch would allow for better control of the path of a towed trailer while turning, using such a trailer hitch would require an unfeasible amount of road space in order to perform turning maneuvers due to the large combined length of the towing vehicle and the towed trailer.

Flexible trailer hitches, such as ball-and-socket hitches, are therefore essential for turning a towing vehicle while towing a trailer or other vehicle. However, this same flexibility makes it difficult to control the path of the trailer while going in reverse. The tendency of a towed trailer to rotate relative to the towing vehicle can cause a towed trailer to swivel or pivot in an undesired direction while turning in reverse or just simply trying to back up in a straight line.

Part of the problem in controlling a reversing trailer is due to an increased lack of visibility. It is often very difficult for the driver of the towing vehicle to see behind and/or around the towed trailer in order to avoid potential hazards and obstacles that may be present, such as other vehicles. This becomes especially pronounced in more crowded urban areas, such as a parking lot.

In addition to sightline issues, it is difficult, from a mechanical/steering point of view, to control the direction of a towed trailer when driving in reverse. When driving in reverse, as opposed to driving forward, the driver of the towing vehicle is no longer aided by the tendency of the towed trailer to “track” the trajectory of the tires of the towing vehicle. The towed trailer is now effectively free-floating in front of the towing vehicle in the direction of movement when moving in reverse, because the driver can only directly control the steering of the tires of the towing vehicle. While the towed trailer is free-floating, it is extremely difficult to accurately control, and “jackknifing”, a phenomenon in which an acute angle is formed between the trailer and the towing vehicle, such that a “V” shape is formed, is a common danger and one that is sometimes impossible to overcome without disconnecting the trailer. One of the biggest problems with controlling a towed trailer when in reverse is that the towed trailer only very slowly responds to a push from the towing vehicle, which causes the driver to overcompensate by turning the steering wheel too much.

Thus, what is needed is an improved means of controlling the movement of a towed trailer while driving in reverse, such that the towed trailer more responsively moves in the desired direction at the start of the reversing action.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an adjustable front axle for a towed trailer. The front axle may be selectively (or automatically) adjusted depending on whether the towing vehicle is driving forward or in reverse, to provide improved steering and control while towing the towed trailer in either direction.

The adjustable front axle may comprise an axle, a hydraulic cylinder, a hydraulic cylinder support, an axle lever, a tie rod, a first tie rod support, a second tie rod support, a first tie rod connector, a second tie rod connector, a first spindle block, a second spindle block, a spindle block shaft, a pivot point, one or more kingpins (for anchoring the pivot point to the spindle block), one or more steering stops, one or more spindles, and electronic connections (to allow the front axle to engage and disengage depending on whether the towing vehicle is driving in reverse).

The adjustable front axle of the present disclosure may be moved between a forward tow position and a reverse tow position, depending on whether the towing vehicle is driving forward or driving in reverse. The position of the adjustable front axle may be adjusted by the actuation of the hydraulic cylinder acting upon the axle lever. The electronic connections made between the hydraulic cylinder and the towing vehicle cause the hydraulic cylinder to automatically actuate into a reverse tow position when the towing vehicle is shifted into reverse, and back to a forward tow position when the towing vehicle is shifted back into forward drive (or park or neutral). For example, the hydraulic cylinder may be configured to actuate between the forward tow position and the reverse tow position based on whether the rear “reverse” taillight of the towing vehicle is on or off.

Shifting the hydraulic cylinder between the forward tow position and the reverse tow position causes, through appropriate mechanical connections described in more detail below, a beneficial shift in the caster and camber angles of the tires secured to the front axle of the towed vehicle. By selectively adjusting the caster and camber angles of the front tires of the towed trailer based on whether the towing vehicle is in forward drive or reverse, the adjustable front axle of the present disclosure provides for a convenient and effective means to optimize driving safely and for providing steering control while towing a trailer when in reverse.

In one embodiment, when the trailer is being towed in the forward direction the caster angle of the front axle of the towed trailer may be at 8 degrees positive caster angle. When the towed system is in reverse, the front axle of the towed trailer is pushed forward, rotating it to the negative caster angle of 6 degrees negative caster angle, which is a total movement of 14 degrees. In some embodiments, the forward or starting caster angle may be in a range of neutral (zero) to 10 degrees, and the reverse or adjusted caster angle may be in a range of −0.001 to −10 degrees.

In the front axle of the present disclosure, a positive caster generates a neutral to negative camber, and a negative caster cause the camber angle to be greater than zero (or positive). This this manner, by changing the caster geometry of the front axle, the camber angle is adjusted, which allows the wheels of the front axle to turn, without any steering or other mechanical assistance, in the same direction as the wheels of the towing vehicle.

In one embodiment, the adjustable front axle may have a positive caster angle when the towing vehicle is in forward drive (1-12 degrees, preferably 2-10 degrees, more preferably 4 to 8 degrees). When the towing vehicle is put into reverse, the adjustable front axle may actuate the axle lever, which rotates the axle, which changes the canter angle to be negative (−0.1 to −12 degrees, preferably −2 to −9 degrees, and more preferably −4 to −7 degrees). When the canter angle moves from positive to negative, the wheel geometry of the adjustable front axle is changed, such that the camber angle moves from being negative (preferably −0.1 to −2.5 degrees, more preferably −0.5 to −1 degrees) or neutral, to being positive (preferably 0.1 to 10 degrees, more preferably 1 to 4 degrees).

In other embodiments, the canter angle shifts from a positive canter angle in the range of 0.1 to 10 degrees to a negative canter angle in the range of −0.1 to −10 degrees and the camber angle shifts from a range of −2 degrees to neutral to a positive range of 0.01 to 4 degrees.

In one embodiment, the actuator may be a hydraulic cylinder with a 2″ bore and a 6″ stroke. The cylinder may be operated with a 12-volt hydraulic pump and two-directional valving. The pivot bearings are also referred to as an axle collar.

The axle may comprise a shaft with two pivot points at the ends of the shaft. The pivot points may engage with the kingpins and the spindle blocks.

Additional benefits of the trailer of the present disclosure is a reduced load on the tongue/hitch. The weight is instead transferred to the adjustable front axle. The trailer of the present disclosure also allows for a tighter or closer turn radius and it shifts the pivot point from the tongue/hitch to the front axle of the trailer. All of these provide superior control over the towed trailer.

One embodiment may be an adjustable front axle for a towed trailer comprising: an axle that comprises an axle shaft and two pivot points, a right pivot point and a left pivot point; an axle lever; an actuator; two spindles, a right spindle and a left spindle; two spindle blocks, a right spindle block and a left spindle block; two wheels, a right wheel and a left wheel; and two kingpins, a right kingpin and a left kingpin; wherein the axle lever may be connected to the axle shaft and may be directly or indirectly articulated by the actuator, such that the actuator may be configured to rotate the axle shaft and the two spindles from a positive canter angle to a negative canter angle; wherein the actuator may be configured to rotate the axle shaft and the two spindles from a positive canter angle to a negative canter angle when a towing vehicle is shifted into reverse; wherein the right pivot point, the right kingpin, and the right spindle block may be interconnected to form a hinge that may be configured to allow the right wheel to turn; wherein the left pivot point, the left kingpin, and the left spindle block may be interconnected to form a hinge that may be configured to allow the left wheel to turn; wherein the left spindle may be connected to the left wheel and the left spindle block, such that when the left spindle block hingedly turns with respect to the left pivot point, the left spindle and the left wheel also turn; wherein the right spindle may be connected to the right wheel and the right spindle block, such that when the right spindle block hingedly turns with respect to the right pivot point, the right spindle and the right wheel also turn; wherein when the axle shaft and the two spindles go from a positive canter angle to a negative canter angle, the camber angle of the two wheels goes from negative or neutral to positive; and wherein when the camber angle of the two wheels may be positive, the adjustable front axle may be automatically steered in the same direction as the towing vehicle when going in reverse. In some embodiments, the adjustable front axle may also include two steering stops, a left steering stop and a right steering stop; wherein the left steering stop may be connected to the left spindle block and the right steering stop may be connected to the right spindle block. Each of the two steering stops may comprise an adjustment portion. In some embodiments the adjustable front axle may also include a tie rod; wherein the tie rod may be connected, directly or indirectly to the axle shaft, the right spindle block and the left spindle block, such that the two spindle blocks may be interconnected, and the two wheels turn in the same direction at the same time.

In some embodiments the adjustable front axle may also comprise two tie rod connectors, a right tie rod connector and a left tie rod connector, and two tie rod stabilizers, a left tie rod stabilizer and a right tie rod stabilizer; wherein the left tie rod stabilizer and the right tie rod stabilizer may each be connected to the tie rod and to the axle shaft; wherein the right tie rod connector may be hingedly connected to the tie rod and may be connected to the right spindle block; and wherein the left tie rod connector may be hingedly connected to the tie rod and may be connected to the left spindle block. In some embodiments, the adjustable front axle may further comprise: a piston; a piston/actuator connector; a piston joint; wherein the piston/actuator connector may be connected to the piston and to the actuator; and wherein the piston may be connected to the axle lever at the piston joint. In some embodiments, the actuator may be connected to a frame of a towed trailer; and wherein the piston may be slideably connected to the frame of the towed trailer.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a plan view of a tow configuration from the prior art.

FIG. 2 is an illustration of a plan view of another tow configuration from the prior art.

FIG. 3 is an illustration of a plan view of one embodiment of a tow configuration having an adjustable front axle.

FIG. 4 is an illustration of one embodiment of a perspective view of an adjustable front axle.

FIG. 5 is an illustration of a side view of one embodiment of an adjustable front axle that changes the canter angle.

FIG. 6 is an illustration of a front perspective view of one embodiment of an adjustable front axle.

FIG. 7 is an illustration of a front perspective close up view of one embodiment of a spindle block and pivot point of an adjustable front axle.

FIG. 8 is an illustration of a front view of an adjustable front axle showing the camber angle change.

FIG. 9 is an illustration of a top view of a spindle block of an adjustable front axle.

FIG. 10 is an illustration of a top plan view of one embodiment of a tow configuration having an adjustable front axle and a pivot tongue draw bar.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. The methods and systems disclosed and described herein may be understood more readily by reference to the following detailed description of preferred embodiments and the examples included therein and to the Figures and their previous and following description. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item or result.

As used herein, the terms “approximately” and “about” generally refer to a deviance of within 5% of the indicated number or range of numbers. In one embodiment, the term “approximately” and “about” may refer to a deviance of between 0.001-10% from the indicated number or range of numbers. Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

As used herein, the term “towing vehicle” refers to any vehicle that may be used in connection with a towed trailer. The term “towing vehicle” may include trucks, smaller personal automobiles, or any other vehicle capable of connecting with, or capable of being modified to connect with, a towed trailer.

As used herein, the term “towed trailer” refers to any wheeled trailer that may be towed by a towing vehicle after being joined by some form of trailer hitch. It is to be understood that vehicles may similarly be towed, as well as trailers, under the adjustable axle of the present disclosure.

As used herein, the term “camber angle” refers to the angle made by the wheels of a vehicle relative to the road surface. The camber angle is the angle between the vertical axis of the wheels used for steering and the vertical axis of the vehicle when viewed from the front or rear. If the top of the wheel is farther out than the bottom (that is, away from the axle), it is called positive camber; if the bottom of the wheel is farther out than the top, it is called negative camber.

As used herein, the term caster angle or castor angle is the angular displacement of the steering axis from the vertical axis of a steered wheel in a vehicle or towed trailer, measured in the longitudinal direction. It is the angle between the pivot line (in a car an imaginary line that runs through the center of the upper ball joint to the center of the lower ball joint) and vertical.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

In accordance with the embodiments disclosed herein, the present disclosure is directed to an adjustable front axle for a towable trailer. The adjustable front axle of the present disclosure serves as a convenient, effective way to improve the safety and handling of driving a trailer, especially while driving in reverse. The position of the adjustable front axle of the present disclosure may be selectively adjusted based on whether the towing vehicle is operating in forward drive or reverse. More specifically, the present disclosure provides a convenient manner to adjust the caster and camber angles of the front axle of a towed trailer to optimize the safety and handling of towing a trailer regardless of whether the driver is operating the towing vehicle in forward drive or reverse.

Before the present methods and systems are disclosed and described in detail, it is to be understood that the methods and systems are not limited to specific methods, specific components, or to particular implementations. It is also to be understood that the terminology used herein is for the purpose of describing particular embodiments only and is not intended to be limiting.

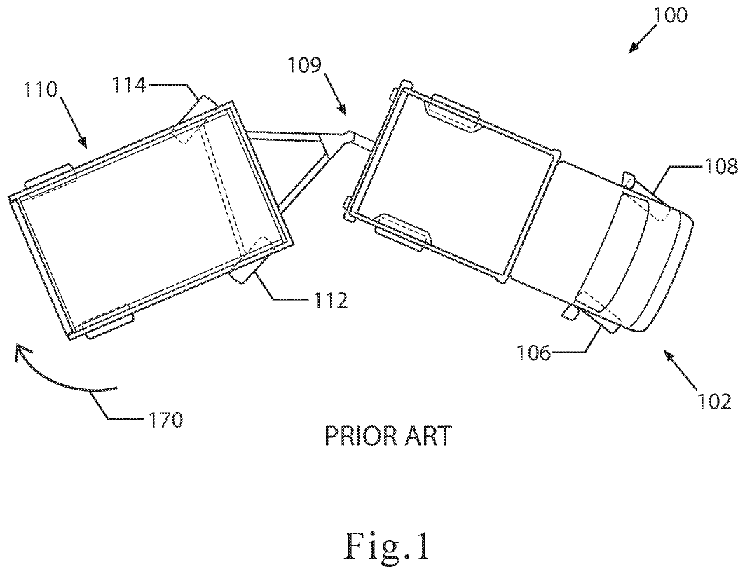

FIG. 1 is an illustration of a plan view of a tow configuration from the prior art. FIG. 1 shows a tow configuration 100 wherein the towed trailer 110 has at least two axles and is hitched to towing vehicle 102 at connection swivel point 109. The standard trailer with at least two axles is designed to maximize the forward geometry of the wheels 112 and 114. However, this means that when the driver turns the wheels 106 and 108 to the right (as shown in FIG. 1) and reverses, the wheels 112, 114 turn to the left on their own (due to the positive canter, neutral to negative camber), which causes the trailer 110 to swing in the wrong direction 170. Thus, unless “reverse steering is used, the trailer 110 does not automatically steer in the correct direction.

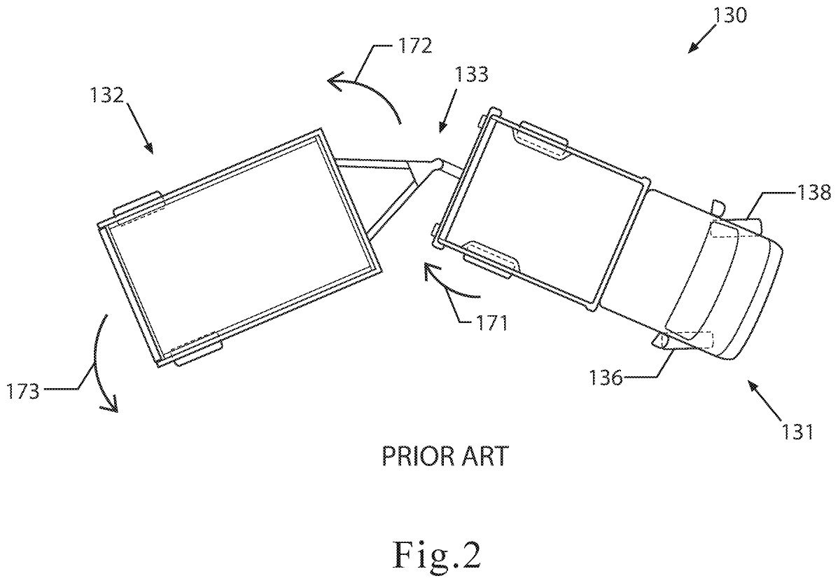

FIG. 2 is an illustration of a plan view of another tow configuration from the prior art. As shown in FIG. 2, the tow configuration 130 has a one axle trailer 132 that requires the user to reverse steer the towing vehicle 131. As shown, the driver must turn the wheels 136, 138 to the left 171 and then back up which causes the trailer 132 (which is connected to vehicle 131 at hitch 133) to turn to the right 172, 173.

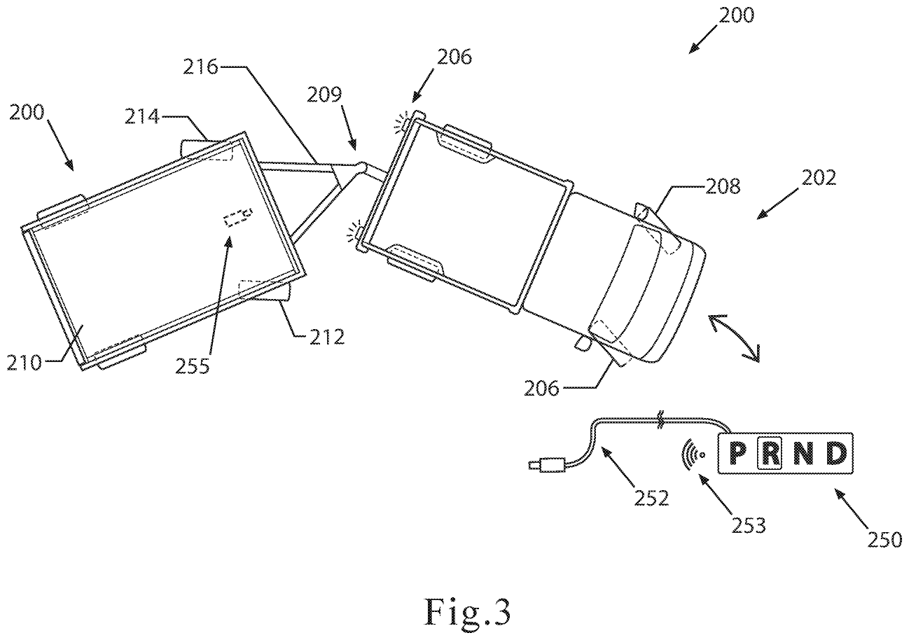

FIG. 3 is an illustration of a plan view of one embodiment of a tow configuration having an adjustable front axle. FIG. 3 shows tow configuration 200 comprises towing vehicle 202, tongue draw bar 216, hitch 209, towed trailer 210 (which may have two or more axles), front vehicle wheels 206, 208, trailer front axle wheels 212, 214, and actuator 255. As shown in FIG. 3, when the vehicle 202 is put into reverse 250 an electric wired 252 or wireless signal 253 is sent to actuator 255, which changes the canter angle from positive to negative, which cause the camber angle of wheels 212 and 214 to go from neutral or negative to positive. As shown in FIG. 3, when the wheel 212, 214 geometry is changed, the wheels 212, 214 automatically turn in the same direction as wheels 206, 208 when reversing. In one embodiment, the actuator may be activated by being connected to the rear tail light 260 electronics of the towing vehicle 202 is electrically coupled 252 to the actuator, such that the actuator 255 actuates when the towing vehicle 202 shifts into reverse 250. In another embodiment, putting the vehicle in reverse may send a wireless signal 253 to the actuator 255, which may be powered by battery, such as the vehicle 202 battery. The actuator, which may be a hydraulic cylinder, may be connected to an axle lever, which may be welded to the center of the top of the axle. The axle lever represents the canter lever that determines the canter angle.

Another benefit of the system of the present disclosure is that the trailer has two axles, which allows a greater and more evenly balanced payload and reduces stress on the hitch 209.

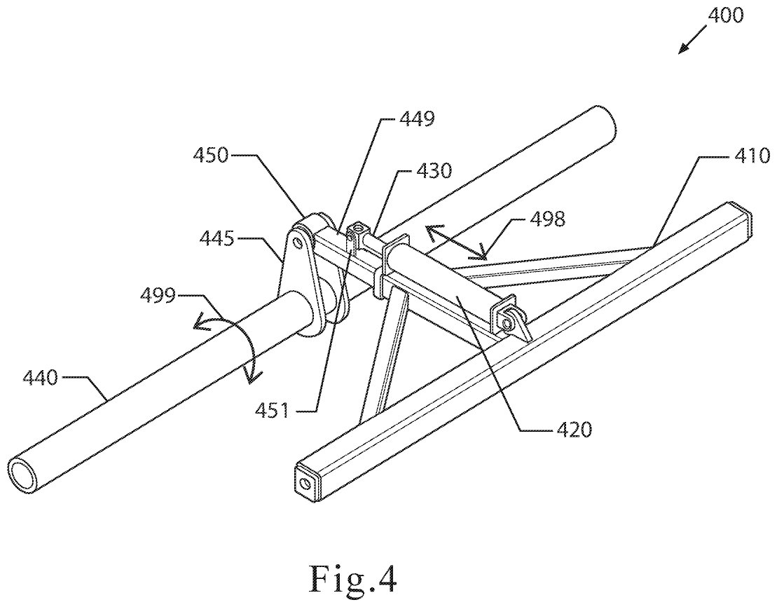

FIG. 4 is an illustration of one embodiment of a perspective view of an adjustable front axle. The adjustable front axle 400 may comprise actuator 420, which is shown as a hydraulic actuator. Actuator 420 may be pneumatic or electric. The adjustable front axle 400 further comprises axle shaft 440, axle lever 445, piston joint 450, piston 449, and piston/actuator connector 451. As shown in FIG. 4, the trailer frame 410 may support actuator 420 and may matingly engage with piston 449, such that piston 449 is held linearly (in this case horizontally), but may piston freely into and out of 498 trailer frame 410. The actuator 420, which is connected to piston 449, moves the piston 449 into and out of 498 the frame 410. The piston 449 (when actuated) also pushes and pulls the axle lever 445 via piston joint 450. When the axle lever 445 is moved by the piston 449, the axle shaft 440 is rotated 499. This rotation 499 changes the canter angle of the axle 440 with respect to the tires of the front axle.

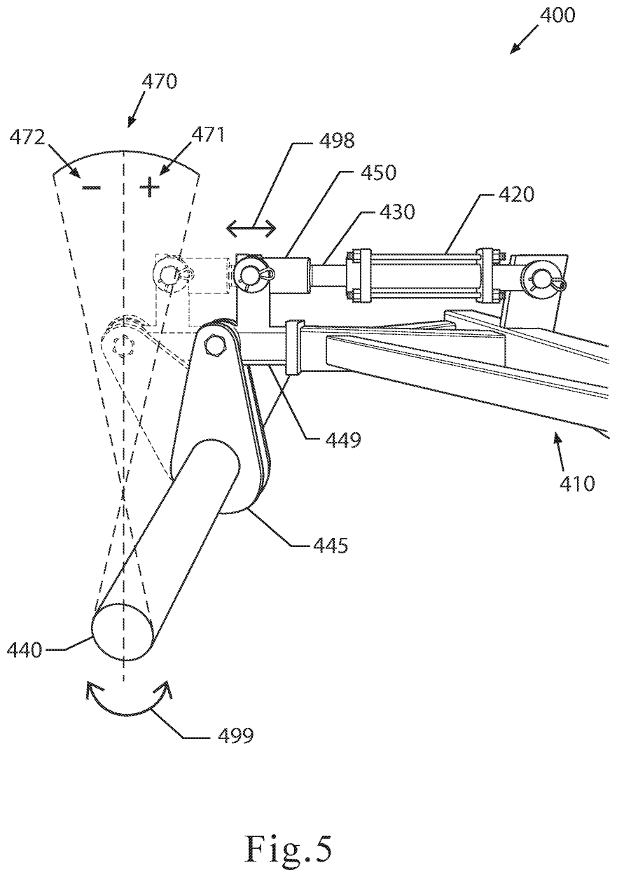

FIG. 5 is an illustration of a side view of one embodiment of an adjustable front axle that changes the canter angle. FIG. 5 shows that the adjustable front axle 400 may comprise the axle 440, axle lever 445, piston joint 450, piston 449, and piston/actuator connector 451. As shown in FIG. 5, the trailer frame 410 may support actuator 420 and may matingly engage with piston 449, such that piston 449 is held linearly (in this case horizontally), but may piston freely into and out of 498 trailer frame 410. The actuator 420 (via actuator piston 430), which is connected to piston 449, moves the piston 449 into and out of 498 the frame 410. The piston 449 (when actuated) also pushes and pulls the axle lever 445 via piston joint 450. When the axle lever 445 is moved by the piston 449, the axle 440 is rotated 499. This rotation 499 changes the canter angle 470 of the axle 440 with respect to the tires of the front axle. When in the forward position, the canter angle 470 is positive 471, to optimize traveling and turning in a forward direction. When in the reverse position, the canter angle 470 may be negative 472, to force the tires to have a positive camber, which causes the tires to turn in the same direction as the towing vehicle when in reverse.

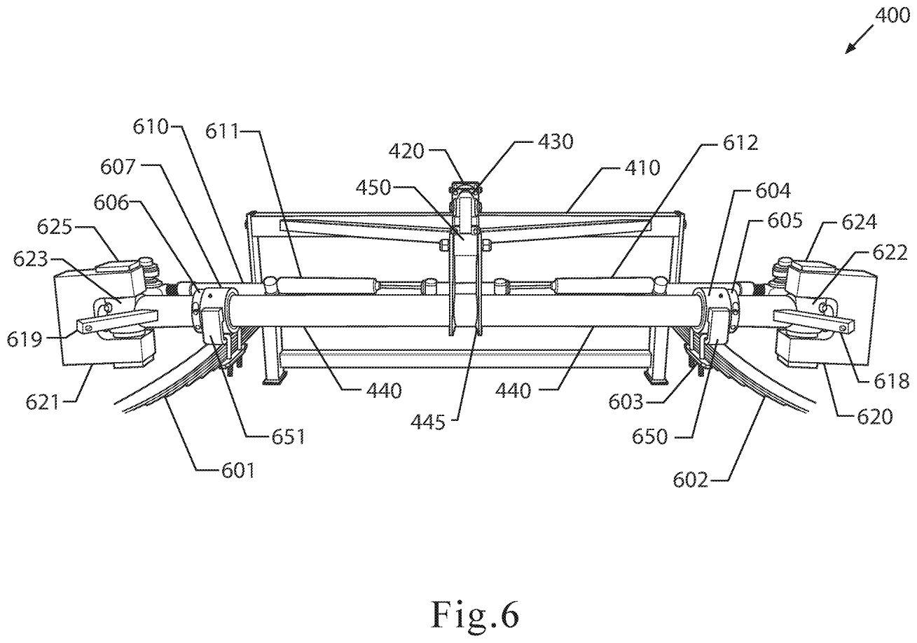

FIG. 6 is an illustration of a front perspective view of one embodiment of an adjustable front axle. The adjustable front axle 400 may comprise actuator 420, axle shaft 440, axle lever 445, piston joint 450, tie rod 610, tie rod stabilizers 611, 612, spindle blocks 621, 622, steering stops 618, 619, pivot points 622, 623, block caps 624, 625, tie rod connectors, pivot bearing collars 605, 606, pivot bearings 604, 607, pivot bearing connectors 650, 651, springs 601, 602, spring connectors 603, and two kingpins. The axle shaft 440 and the pivot points 622, 623 may preferably be one unitary piece or they may be welded together. The tie rod 610 provides support to the axle shaft 440 and connects the two spindle blocks 621, 622, so that the wheels do not toe or turn in opposite directions. The spindle blocks 621, 622 are rotatably connected to the pivot points 622, 623 via the kingpins. The front axle wheels, which are attached to spindles, which are attached to the spindle blocks 621, 622, turn in synchronicity with each other (due to the tie rod 610), but they are prevented from turning too far (and jackknifing) by steering stops 618, 619. The pivot bearing collars 605, 606 keep the pivot bearings 604, 607 in place along the axle shaft 440. The pivot bearings 604, 607 connect the axle shaft 440 to the trailer via pivot bearing connectors 650, 651. FIG. 6 shows that the pivot bearing connectors 650, 651 are connected to the springs 601, 602, which are connected to the frame of the trailer and act as shocks. The pivot bearings 604, 607 allow the axle to freely rotate.

The tie rod stabilizers are 611, 612 may be springs (compression, torsion, tension, volute or leaf) or simply a non-spring telescopic rod that allows the axle to be rotated by the actuator 420, without forcing the spindle blocks 620, 621 and/or tie rod 610 to be overly torqued.

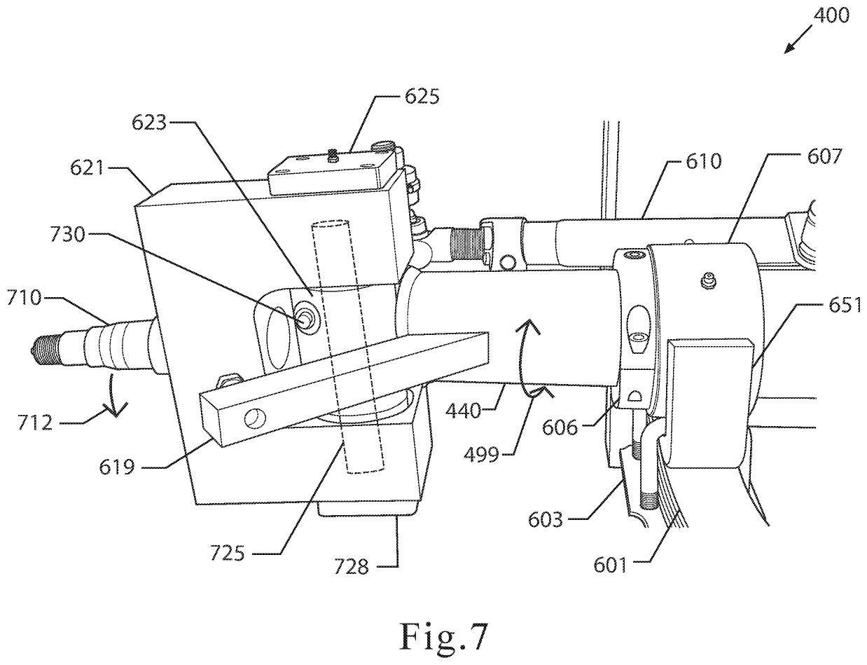

FIG. 7 is an illustration of a front perspective close up view of one embodiment of a spindle block and pivot point of an adjustable front axle. As shown in FIG. 7, the adjustable front axle 400 may comprise axle shaft 440, tie rod 610, spindle block 621, steering stop 619, pivot point 623, block caps 625, 728, pivot bearing collar 606, pivot bearing 607, pivot bearing connector 651, spring 601, spring connector 603, kingpin 725, vertical stabilizer bolt 730, and spindle 710. FIG. 7 shows that the pivot point 623, kingpin 725, and spindle block 621 form a hinge that guide how the front axle wheels turn. The spindle 710 is part of or connected to the front side of the spindle block 621. The spindle may directly or indirectly connect to the front axle wheel. The axle shaft 440 may be welded to the pivot point 623, such that when the axle shaft 440 is rotated 499, the pivot point 623 also rotates. When the pivot point 623 rotates, the kingpin 725 causes the spindle block 621 and spindle 710 to rotate in the same direction. As the spindle 710 rotates from a positive canter to a negative canter, the camber angle is shifted to be positive (or to be more positive).

The two block caps 625, 728 are preferably made from aluminum and they hold the kingpin 725 in place and, when removed, allow access to the kingpin 725. The vertical stabilizer bolt engages with the kingpin 725 to further secure the kingpin 725 in place and secure the axle/shaft and spindle block 621 and related axle portions.

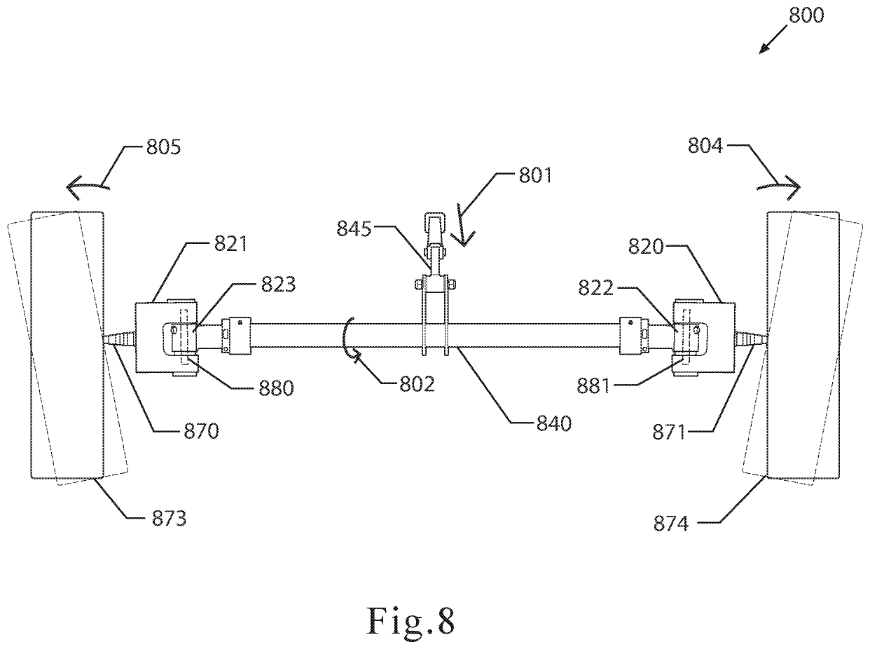

FIG. 8 is an illustration of a front view of an adjustable front axle showing the camber angle change. FIG. 8 shows one embodiment of an adjustable front axle 800 comprising axle 840, axle lever 845, spindle blocks 820, 821, pivot points 822, 823, kingpins 880, 881, spindles 870, 871, and wheels 873, 874. FIG. 8 does not show the pivot bearings. FIG. 8 shows that when the axle lever 845 is moved forward 801, the axle 840 and spindle blocks 821, 820 are rotated forward 802, such that the canter angle may go from positive to negative, which changes the wheel geometry of the adjustable front axle 800, such that the camber angle is moved from negative or neutral to positive 804, 805.

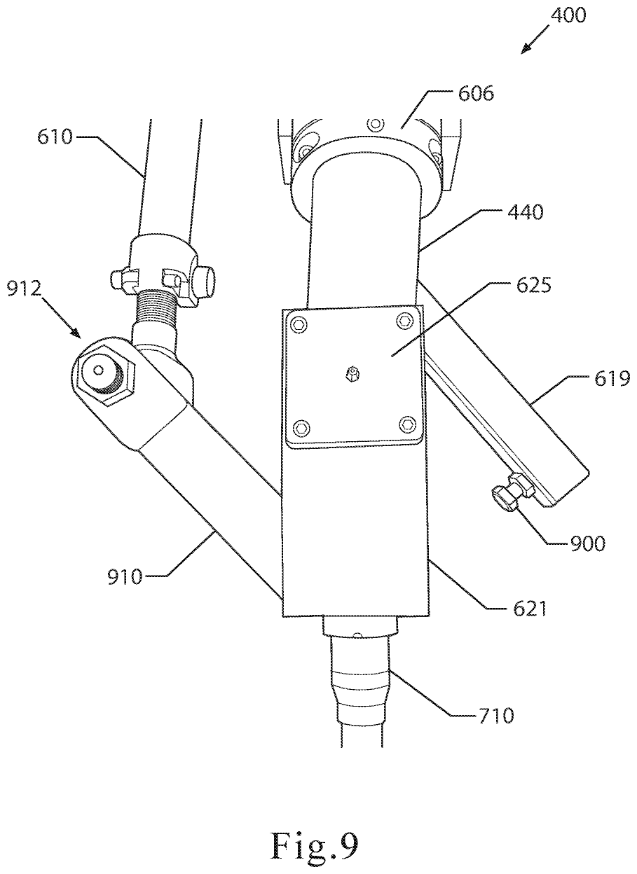

FIG. 9 is an illustration of a top view of a spindle block of an adjustable front axle. FIG. 9 shows that adjustable front axle 400 may comprise tie rod connector 910, tie rod connector joint 912, tie rod 610, axle shaft 440, pivot bearing collar 606, spindle 710, spindle block 621, steering stop 619, steering stop adjustment portion 900, and spindle block cap 625. FIG. 9 shows that the tie rod 610 may be hingedly connected to the tie rod connector 910 via tie rod connector joint 912. The tie rod connector 910 may be welded or otherwise permanently affixed to the spindle block 621. The steering stop adjustment portion 900 allows the user to adjust the turning radius of the wheels of the front axle 400 of the towed trailer. The tie rod connector 910 and/or said steering stop 619 may be unitarily part of said spindle block 621.

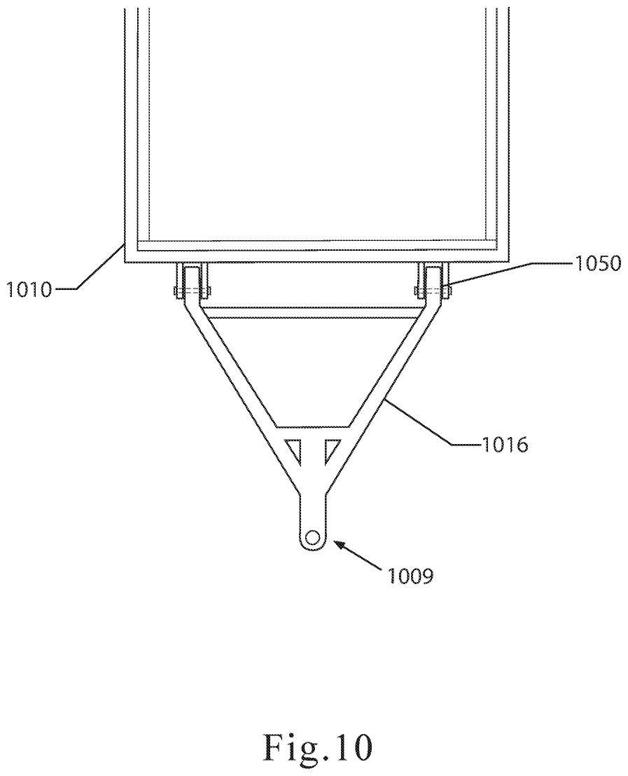

FIG. 10 is an illustration of a top plan view of one embodiment of a tow configuration having an adjustable front axle and a pivot tongue draw bar. As shown in FIG. 10, the trailer may have a tongue draw bar 1016 that is pivotably attached to the towed trailer 1010 at pivot point 1050. The tongue draw bar 1016 may be attached to the towing vehicle at hitch 1009. This pivotable tongue serves to eliminate any and all excess weight put on the towing vehicle by the a towed trailer, even if the height of the towed trailer 1010 is lower than that of the towing vehicle. Rather than the weight being transferred from the front axel of the towed trailer 1010 to the hitch 1009 (and thus the towing vehicle), the draw bar 1016 merely pivots upward and the weight stays on the front axel of the towed trailer 1010. When the weight of the trailer load stays on the towed trailer 1010 and is not transferred to the towing vehicle, the front axle of the towed trailer 1010 is more responsive and allows for a tighter turning radius.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit of the present disclosure. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An adjustable front axle for a towed trailer comprising:
an axle that comprises an axle shaft and two pivot points, a right pivot point and a left pivot point;
an axle lever;
an actuator;
two spindles, a right spindle and a left spindle;
two spindle blocks, a right spindle block and a left spindle block;
two wheels, a right wheel and a left wheel; and
two kingpins, a right kingpin and a left kingpin;
wherein said axle lever is connected to said axle shaft and is directly or indirectly articulated by said actuator, such that said actuator is configured to rotate said axle shaft and said two spindles from a positive canter angle to a negative canter angle;
wherein said actuator is configured to rotate said axle shaft and said two spindles from a positive canter angle to a negative canter angle when a towing vehicle is shifted into reverse;
wherein said right pivot point, said right kingpin, and said right spindle block are interconnected to form a hinge that is configured to allow said right wheel to turn;
wherein said left pivot point, said left kingpin, and said left spindle block are interconnected to form a hinge that is configured to allow said left wheel to turn;
wherein said left spindle is connected to said left wheel and said left spindle block, such that when said left spindle block hingedly turns with respect to said left pivot point, said left spindle and said left wheel also turn;
wherein said right spindle is connected to said right wheel and said right spindle block, such that when said right spindle block hingedly turns with respect to said right pivot point, said right spindle and said right wheel also turn;
wherein when said axle shaft and said two spindles go from a positive canter angle to a negative canter angle, said camber angle of said two wheels goes from negative or neutral to positive; and
wherein when said camber angle of said two wheels is positive, the adjustable front axle is automatically steered in the same direction as said towing vehicle when going in reverse.

2. The adjustable front axle of claim 1, further comprising:
two steering stops, a left steering stop and a right steering stop;
wherein said left steering stop is connected to said left spindle block and said right steering stop is connected to said right spindle block.

3. The adjustable front axle of claim 2, wherein each of said two steering stops comprises an adjustment portion.

4. The adjustable front axle of claim 1, further comprising:
a tie rod;
wherein said tie rod is connected, directly or indirectly to said axle shaft, said right spindle block and said left spindle block, such that said two spindle blocks are interconnected and said two wheels turn in the same direction at the same time.

5. The adjustable front axle of claim 4, further comprising:
two tie rod connectors, a right tie rod connector and a left tie rod connector; and
two tie rod stabilizers, a left tie rod stabilizer and a right tie rod stabilizer;
wherein said left tie rod stabilizer and said right tie rod stabilizer are each connected to said tie rod and to said axle shaft;
wherein said right tie rod connector is hingedly connected to said tie rod and is connected to said right spindle block; and
wherein said left tie rod connector is hingedly connected to said tie rod and is connected to said left spindle block.

6. The adjustable front axle of claim 1, further comprising:
a piston;
a piston/actuator connector;
a piston joint;
wherein said piston/actuator connector is connected to said piston and to said actuator; and
wherein said piston is connected to said axle lever at said piston joint.

7. The adjustable front axle of claim 6, wherein said actuator is connected to a frame of a towed trailer;
wherein said piston is slideably connected to said frame of said towed trailer; and
wherein said towed trailer has a pivotable draw bar.

8. An adjustable front axle for a towed trailer comprising:
an axle that comprises an axle shaft and two pivot points, a right pivot point and a left pivot point;
an axle lever;
an actuator;
two spindles, a right spindle and a left spindle;
two spindle blocks, a right spindle block and a left spindle block;
two wheels, a right wheel and a left wheel;
two kingpins, a right kingpin and a left kingpin;
a tie rod;
a piston;
a piston/actuator connector; and
a piston joint;
wherein said tie rod is connected, directly or indirectly to said axle shaft, said right spindle block and said left spindle block, such that said two spindle blocks are interconnected and said two wheels turn in the same direction at the same time;
wherein said piston/actuator connector is connected to said piston and to said actuator;
wherein said piston is connected to said axle lever at said piston joint;
wherein said axle lever is connected to said axle shaft and is articulated by said actuator through said piston, said piston/actuator connector, and said piston joint, such that said actuator is configured to rotate said axle shaft and said two spindles from a positive canter angle to a negative canter angle;
wherein said actuator is configured to rotate said axle shaft and said two spindles from a positive canter angle to a negative canter angle when a towing vehicle is shifted into reverse;
wherein said right pivot point, said right kingpin, and said right spindle block are interconnected to form a right hinge that is configured to allow said right wheel to turn;
wherein said left pivot point, said left kingpin, and said left spindle block are interconnected to form a left hinge that is configured to allow said left wheel to turn;
wherein said left spindle is connected to said left wheel and said left spindle block, such that when said left spindle block hingedly turns with respect to said left pivot point, said left spindle and said left wheel also turn;
wherein said right spindle is connected to said right wheel and said right spindle block, such that when said right spindle block hingedly turns with respect to said right pivot point, said right spindle and said right wheel also turn;
wherein when said axle shaft and said two spindles go from a positive canter angle to a negative canter angle, said camber angle of said two wheels goes from negative or neutral to positive; and
wherein when said camber angle of said two wheels is positive, the adjustable front axle is automatically steered in the same direction as said towing vehicle when going in reverse.

9. The adjustable front axle of claim 8, further comprising:
two steering stops, a left steering stop and a right steering stop;
wherein said left steering stop is connected to said left spindle block and said right steering stop is connected to said right spindle block.

10. The adjustable front axle of claim 9, wherein each of said two steering stops comprises an adjustment portion.

11. The adjustable front axle of claim 8, further comprising:
two tie rod connectors, a right tie rod connector and a left tie rod connector; and
two tie rod stabilizers, a left tie rod stabilizer and a right tie rod stabilizer;
wherein said left tie rod stabilizer and said right tie rod stabilizer are each connected to said tie rod and to said axle shaft;
wherein said right tie rod connector is hingedly connected to said tie rod and is connected to said right spindle block; and
wherein said left tie rod connector is hingedly connected to said tie rod and is connected to said left spindle block.

12. The adjustable front axle of claim 8, wherein said actuator is connected to a frame of a towed trailer; and
wherein said piston is slideably connected to said frame of said towed trailer; and
wherein said towed trailer has a pivotable draw bar.

13. An adjustable front axle for a towed trailer comprising:
an axle that comprises an axle shaft and two pivot points, a right pivot point and a left pivot point;
an axle lever;
an actuator;
two spindles, a right spindle and a left spindle;
two spindle blocks, a right spindle block and a left spindle block;
two wheels, a right wheel and a left wheel;
two kingpins, a right kingpin and a left kingpin; and
wherein said axle lever is connected to said axle shaft and is directly or indirectly articulated by said actuator, such that said actuator is configured to rotate said axle shaft and said two spindles from a positive canter angle in the range of 2 to 10 degrees to a negative canter angle in the range of −2 to −10 degrees;
wherein said actuator rotates said axle shaft and said two spindles from a positive canter angle in the range of 2 to 10 degrees to a negative canter angle in the range of −2 to −10 degrees when a towing vehicle is shifted into reverse;
wherein said right pivot point, said right kingpin, and said right spindle block are interconnected to form a right hinge that is configured to allow said right wheel to turn;
wherein said left pivot point, said left kingpin, and said left spindle block are interconnected to form a left hinge that is configured to allow said left wheel to turn;
wherein said left spindle is connected to said left wheel and said left spindle block, such that when said left spindle block hingedly turns with respect to said left pivot point, said left spindle and said left wheel also turn;
wherein said right spindle is connected to said right wheel and said right spindle block, such that when said right spindle block hingedly turns with respect to said right pivot point, said right spindle and said right wheel also turn;
wherein when said axle shaft and said two spindles go from a positive canter angle to a negative canter angle, said camber angle of said two wheels goes from a range of −2 degrees to neutral to a positive range of 0.5 to 4 degrees; and
wherein when said camber angle of said two wheels is positive, the adjustable front axle is automatically steered in the same direction as said towing vehicle when going in reverse.

14. The adjustable front axle of claim 13, further comprising two steering stops, a left steering stop and a right steering stop;
wherein said left steering stop is connected to said left spindle block and said right steering stop is connected to said right spindle block.

15. The adjustable front axle of claim 14, wherein each of said two steering stops comprises an adjustment portion.

16. The adjustable front axle of claim 13, further comprising:
a tie rod;
wherein said tie rod is connected, directly or indirectly to said axle shaft, said right spindle block and said left spindle block, such that said two spindle blocks are interconnected and said two wheels turn in the same direction at the same time.

17. The adjustable front axle of claim 16, further comprising:
two tie rod connectors, a right tie rod connector and a left tie rod connector; and
two tie rod stabilizers, a left tie rod stabilizer and a right tie rod stabilizer;
wherein said left tie rod stabilizer and said right tie rod stabilizer are each connected to said tie rod and to said axle shaft;
wherein said right tie rod connector is hingedly connected to said tie rod and is connected to said right spindle block; and
wherein said left tie rod connector is hingedly connected to said tie rod and is connected to said left spindle block.

18. The adjustable front axle of claim 13, further comprising:
a piston;
a piston/actuator connector;
a piston joint;
wherein said piston/actuator connector is connected to said piston and to said actuator; and
wherein said piston is connected to said axle lever at said piston joint.

19. The adjustable front axle of claim 18, wherein said actuator is connected to a frame of a towed trailer; and
wherein said piston is slideably connected to said frame of said towed trailer.

20. The adjustable front axle of claim 13, wherein said towed trailer has a pivotable draw bar.
